(19) United States
(12) Patent Application Publication
(10) Pub. No.: US 2009/0315478 A1
(43) Pub. Date: Dec. 24, 2009

(54) LIGHTING SYSTEM HAVING MASTER AND SLAVE LIGHTING FIXTURES

(76) Inventors: Jerry L. McColgin, Westfield, IN (US); Thomas F. Foust, Carmel, IN (US); Scott R. McColgin, Westfield, IN (US)

Correspondence Address: PATENT DOCKET CLERK;COWAN, LIEBOWITZ & LATMAN, P.C., 1133 AVENUE OF THE AMERICAS, NEW YORK, NY, 10036, US

(21) Appl. No.: 12/484,478

(22) Filed: Jun. 15, 2009

Related U.S. Application Data
(60) Provisional application No. 61/073,908, filed on Jun. 19, 2008.

(51) Int. Cl. H05B 37/02

(52) U.S. Cl. 315/294

(57) ABSTRACT

A lighting system includes a master lighting fixture and at least one slave lighting fixture. Each lighting fixture includes a base, a light source, and a controller. The master lighting fixture includes a master controller contained within its base and a set of buttons to control the operation of all of the lighting fixtures. The master controller wirelessly transmits a control signal to the slave lighting fixtures depending on depression of the buttons by a user in order to be able to individually control all of the lighting fixtures in the system by utilizing buttons on the master lighting fixture. The fixtures may be disposed anywhere within a room or other location, and, without the need for additional wiring, operation of one device allows for the control of all of the devices within the system. Each lighting fixture may be in the form of a standard table lamp, floor lamp or other form of lighting fixture.

### REFERENCE TO RELATED APPLICATION

This application claims priority to U.S. Provisional Patent Application No. 61/073,908, filed Jun. 19, 2008. The disclosure of U.S. Provisional Patent Application No. 61/073,908 is incorporated herein by reference.

### FIELD OF THE INVENTION

This invention relates to a lighting system and, more particularly, to a network of automatically and remotely controlled set of master/slave lighting fixtures.

### BACKGROUND OF THE INVENTION

It is often convenient and thus desirable to easily operate multiple lighting fixtures throughout a room within a home or building. It is also desirable to operate multiple lighting fixtures at the same time, but without employing additional wiring and other expensive and cumbersome electrical devices.

### OBJECTS AND SUMMARY OF THE INVENTION

In view of the foregoing, it is an object of the present to provide a lighting system that is easily and conveniently controlled without the need for expensive or cumbersome wiring.

It is another object of the present invention to provide a lighting system that is designed to enable a user to easily set multiple lighting fixtures to respective intensity levels, as well as respective pre-set levels.

These and other objects are achieved by a lighting system that comprises a master lighting fixture having a base, a light source, a set of control buttons, and a master controller contained within the base, and one or more slave lighting fixtures, each of the slave lighting fixtures having a base, a light source, and a slave controller fully contained within the base of the respective slave lighting fixture. The master controller is adapted to control, in response to selective depression of the control buttons, an intensity level of the light source of the master lighting fixture and to wirelessly transmit a control signal to the slave lighting fixtures. The transmitted control signal corresponds to an intensity level of the slave lighting fixtures. The slave controller of each slave lighting fixture includes a receiver for receiving the transmitted control signal and designed to control an intensity level of the light source of the respective slave lighting fixture based on the received control signal.

As an aspect of the present invention, the control buttons on the master lighting fixture include a dedicated button for each lighting fixture which is designed to selectively control the intensity level of the light source of the respective lighting fixture.

As another aspect of the present invention, the master controller in the master lighting fixture is designed to selectively cycle a selected lighting fixture through a plurality of intensity levels upon multiple depressions of the respective dedicated button.

As a further aspect of the present invention, the master controller includes memory for storing the previously set intensity levels of each of the lighting fixtures.

As an additional aspect of the present invention, the system includes a remote control having multiple buttons and that is adapted to wirelessly transmit a remote control signal in accordance with depression of the buttons by a user of the remote control. The master controller is adapted to receive the transmitted remote control signal and to selectively establish one or more lighting fixtures to a respective intensity level in accordance with the received remote control signal.

As yet a further aspect of the present invention, the master controller and each slave controller receive the transmitted remote control signal and establish the intensity level of the respective lighting fixture in accordance with the received remote control signal.

As yet another aspect of the present invention, the master lighting fixture and the slave lighting fixtures are table lamps.

As yet an additional aspect of the present invention, the master lighting fixture and the slave lighting fixtures have matching (or perhaps identical) appearances.

As a further aspect of the present invention, the system includes different types of lamps. For instance, the master lighting fixture is a table lamp or a floor lamp, and at least one of the slave lighting fixtures is the other type of lamp.

Various other objects, advantages and features of the present invention will become readily apparent to those of ordinary skill in the art from the following detailed description of the invention.

### BRIEF DESCRIPTION OF THE DRAWINGS

The following description, given by way of example and not intended to limit the present invention solely thereto, will be best appreciated in conjunction with the accompanying drawings, wherein like reference numerals denote like elements and parts, in which:

FIG. 1 is a schematic illustration of a room setting including a representative lighting system that operates in accordance with the present invention; and

FIG. 2 is schematic illustration of a further room setting in which a further lighting system operates in accordance with the present invention.

### DETAILED DESCRIPTION OF THE INVENTION

The present invention relates to improvements in ordinary lighting fixtures, such as lamps, including bedroom lamps and other types of lighting fixtures. In accordance with the invention disclosed herein, a lighting system includes at least two lighting fixtures, also called a network of lighting fixtures (or “lights”) herein, in which the lighting fixtures operate according to a “master-slave” relationship. In particular, a first lighting fixture operates as the master, which controls the respective operation of each of the other lighting fixtures, which operate as the slaves. The master lighting fixture preferably communicates with the slave lighting fixtures through the use of well-known radio frequency technology, although other types of wireless communication may be employed.

The master lighting fixture includes an array of buttons for controlling its operation as well as the operation of each of the slave lighting fixtures. The master lighting fixture and each of the slave lighting fixtures may also be controlled by a single remote control. In addition, each of the master and slave lighting fixtures includes internal memory configured to retain the most recent lighting level. This way, all of the lights can return to that last, most recent lighting level when they are again turned on, thereby avoiding the need for adjustment.

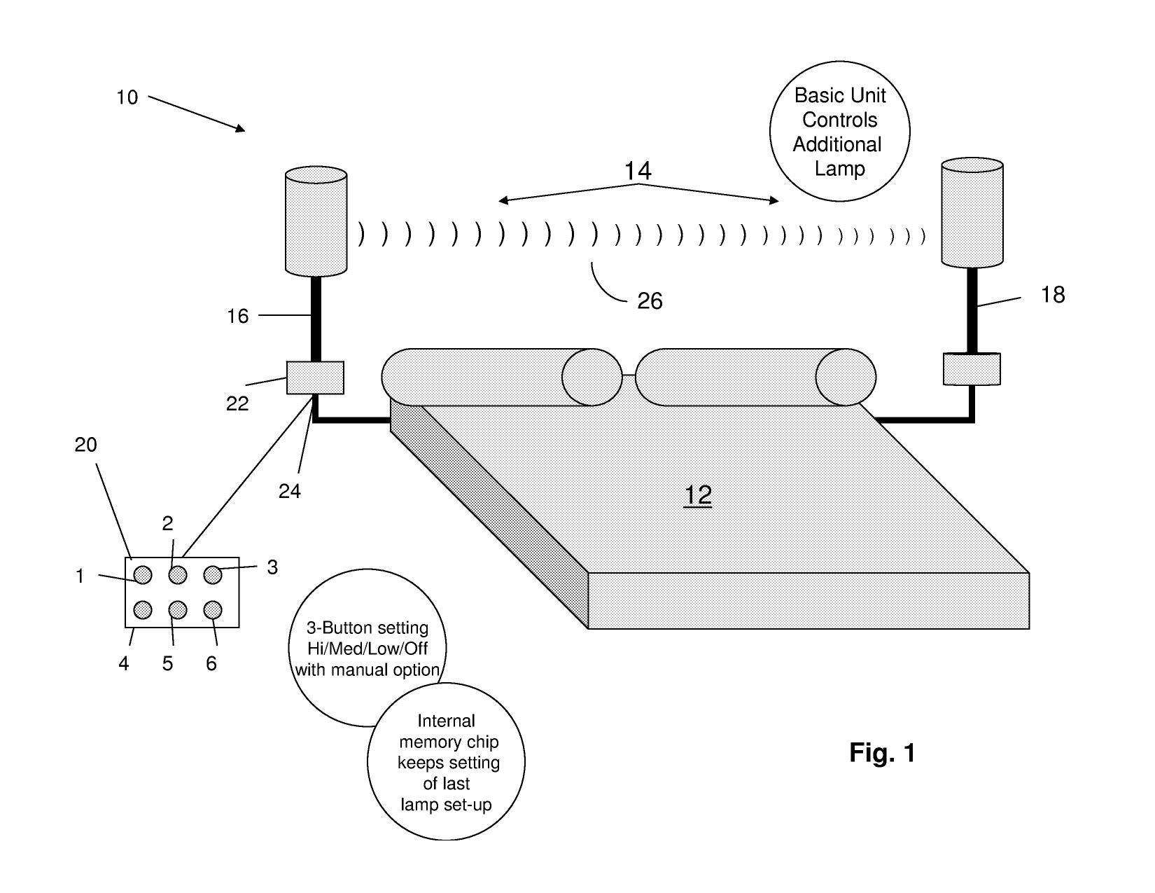

Referring to FIG. 1 of the accompanying drawings, there is provided a first embodiment of the present invention. As may be seen, a bedroom arrangement 10 typically found in many households is provided. The arrangement 10 includes a bed 12 flanked by lighting fixtures 14. Lighting fixtures 14 are provided, optionally, as a pair of bedside lamps 16 and 18. Each of the lamps 16 and 18 includes its own three-button setting (high, medium and low) to allow an operator to choose a desired level of lighting. Of course, a different number of settings (e.g., on/off only, 5 settings—high, medium-high, medium, medium-low, low, or another number of settings) may be employed.

The lamps 16 and 18 are operable according to the master-slave relationship discussed above, in which lamp 16 is designed to be the master lamp, and includes control buttons 20 preferably at the rear 22 of its base 24. Optionally, buttons 20 are covered by a flap (not shown) or other mechanism to hide the buttons for aesthetic purposes. As herein described, buttons 20 may be utilized to control the operation of master lamp 16 and/or to control the operation of slave lamp 18. Preferably, one or more buttons are used to selectively regulate each lamp to a variable lighting level. As mentioned above, multiple lighting levels may be provided. Control buttons 20 include one or more buttons to turn each of the lamps on or off, as desired. One or more additional buttons are included preferably to control each of the lamps to return to their previously set state, such as when a lamp is turned on from an off state. Such buttons may further, when depressed, cause each of the lamps to be set to a respective state as stored in the lamps' respective memories.

As mentioned herein, master lamp 16 employs wireless communication to control slave lamp 18, which appropriately includes a suitable receiver for receiving the wireless communication (as presented by signals 26 in FIG. 1). If the system of the present invention includes a second, third or more slave lamps, such slave lamps likewise operate to receive signals sent wirelessly from master lamp 16. Preferably, the signals are encoded to identify the respective slave lamp that should be controlled.

As described herein, each of the lamps 16 and 18 is provided with an internal memory that stores the last lighting level to which the respective lamp was set prior to being turned off. At least one button on master lamp 16 is configured when pressed to return each of the lamps 16 and 18 to such last setting. Accordingly, the operator is able to bypass having to manually adjust each of the lamps 16 and 18 to the previously set level.

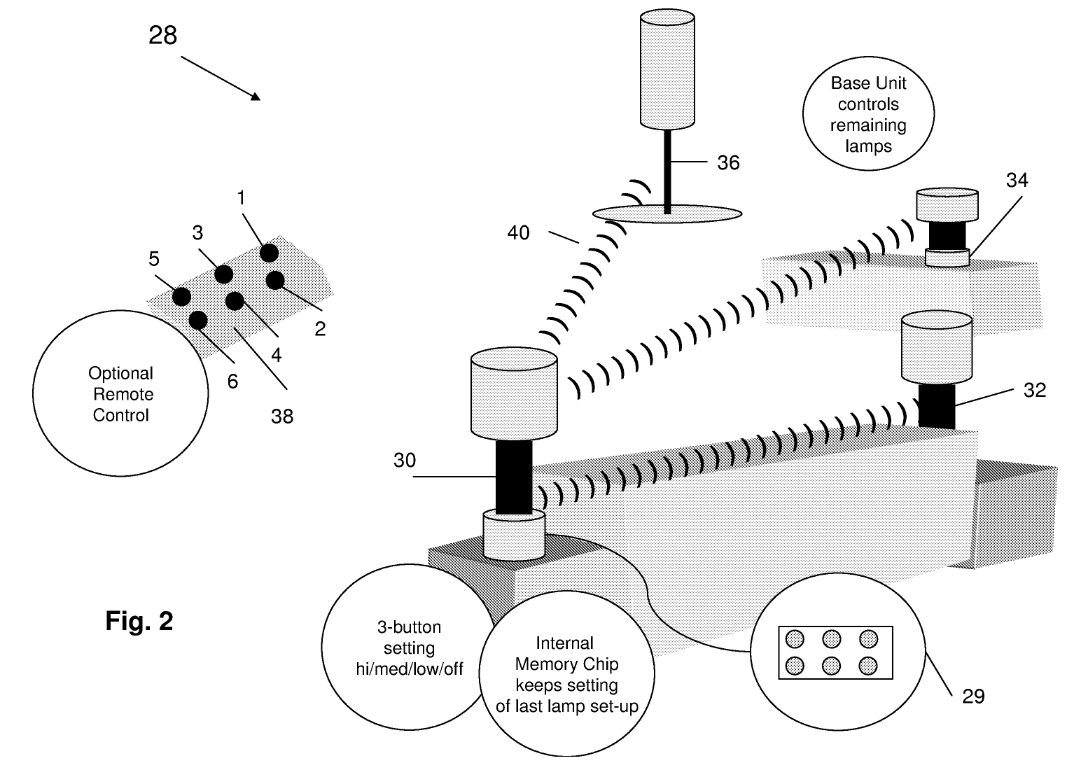

Referring now to FIG. 2, there is provided a second embodiment of the present invention. A representative arrangement of a living room 28 like that which may be found in a common household is shown. Such an arrangement includes multiple table lamps 30, 32, and 34 and a floor lamp 36, each including its own high, medium and low settings (or another number of settings). As in the discussion provided above, each of the lamps 30, 32, 34 and 36 operates according to the above-described master-slave relationship. In the exemplary illustration, lamp 30 is the master lamp and lamps 32, 34 and 36 are its slaves.

Master lamp 30, similar to master lamp 16, includes an arrangement of control buttons 29. In this embodiment, each of the lamps 30, 32, 34 and 36 are further controllable through use of a remote control 38. Remote control 38 includes a similar arrangement of button controls that are included on the base of master lamp 30.

To control slave lamps 32, 34 and 36, a user depresses an appropriate button on the remote control 38 in order to control one or more desired lamps, at which point, master lamp 30 sends an appropriate control signal (represented by signal 40 in FIG. 2) to the lamps. Each of the slave lamps receive the transmitted signal and respond accordingly. In a variation, all of the lamps, including the slave lamps, receive the signal transmitted by the remote control and operate accordingly. The user may use remote control 38 to control all of the lamps simultaneously or to control an individual lamp. In particular, the user may depress an appropriate button on remote control 38 to set all of the lamps to their maximum intensity level, to a pre-set level, or off. The user may depress an appropriate button on remote control 38 to simultaneously set each of the lamps to their respective next higher intensity level or their respective next lower intensity level. The user may depress an appropriate button on remote control 38 to set an individual lamp to a desired intensity level or off, as desired.

In yet a further embodiment, the master lamp (either master lamp 16 shown in FIG. 1 and/or master lamp 30 shown in FIG. 2) retains in memory pre-stored intensity levels of all of the lamps in the system and, in such case, the slave lamps need not include their own respective memory or other type of internal storage. The operation of the lamps from the user's perspective, however, remains the same, with the user being provided with the capability of controlling all of the lamps in the system, as desired, or controlling an individual lamp in the system.

In FIGS. 1 and 2, each of the master lamps and the remote control are shown as including 6 buttons, but the present invention is not limited to such number. For example, a master lamp and/or remote control may contain 8 buttons or other number of buttons, as appropriate. In one example, in connection with the 6 buttons shown in the drawings, button 1 is depressed to control the variable lighting level of the master lamp, buttons 2, 3 and 4 are depressed to respectively control the variable lighting levels of slave lamps 32, 34 and 36; button 5 is utilized via a first depression to turn all of the lamps in the system off, and upon a second depression to turn on the lamps and to set their intensity levels to their respective pre-set levels (i.e., as stored in memory), and button 6 is used via a first depression to turn all of the lamps in the system to their respective highest intensity level, and upon a second depression to turn all of the lamps in the system off. Other manners of control may be employed.

In each of the embodiments described herein, each lamp (i.e., master lamp and all slave lamps) includes the well-known components of an ordinary lighting fixture, including a power cord, a base, a light socket for holding a bulb, and a bulb. Preferably, as described above, one or more lamps in the system may be set to different intensity levels. The bulbs may be incandescent, fluorescent, LEDs, or other suitable technology. In accordance with the present invention, the master lamp further contains multiple control buttons as herein described, along with control circuitry coupled to those control buttons and a transmitter, with such control circuitry and transmitter adapted to implement the operations described herein. Since such control circuitry can be designed by one of ordinary skill in the art given the description provided herein, further discussion of the control circuitry, as well as the transmitter, is not provided except where necessary for an understanding of the present invention. In connection with each of the slave lamps, such lamps further include a receiver designed to receive the signal provided by the transmitter within the master lamp.

Each of the slave lamps further includes suitable control circuitry for decoding the signal received by the lamp's receiver and to set the intensity level of the lamp in accordance with such decoded signal. In addition, in certain embodiments as described herein, each slave lamp includes suitable internal memory. The control circuitry and the transmitter, as well the memory if included, of each of the slave lamps may be separate components or integrated into a single component, and since the design of such control circuitry, transmitter and memory are within the ability of one of ordinary skill in the art, further description thereof is not provided except where necessary for an understanding of the present invention.

In the embodiment shown in FIG. 1, the lighting system of the present invention includes master lamp 16 and slave lamp 18. Preferably, Lamps 16 and 18 are identical in appearance (or nearly identical) so that to an ordinary observer they appear to be identical lamps. Additional slave lamps may be provided in the system, wherein such additional slave lamps also are identical in appearance to the other lamps in the system. In the embodiment shown in FIG. 2, each of the lamps in the system preferably also are identical or similar in appearance, that is, represent matching lamps suitable for use in a single room. However, in other versions, the lamps within the system may be significantly dissimilar in appearance.

The present invention has been described as a system of lighting fixtures for use in a room of a house or other type of building. It is be understood however that the lamps within the system may be placed throughout multiple rooms or even multiple buildings, and generally is limited to the communication range of the transmitted signal. Although the system preferably is designed to be inexpensive and thus in one implementation may employ technology suitable for use in a relatively small area, such as a large room in a house or other type of structure, other implementations may employ technology suitable for far larger areas, such as auditoriums, concert halls, arenas, office buildings, and so on.

In addition, although the present invention has been described as including lighting fixtures in the form of table and floor lamps, such as shown in FIGS. 1 and 2, other types of lamps may be employed, including but not limited to desk lamps and mounted fixtures. However, in certain implementations, in an effort to keep costs reasonably low, systems for home use may be designed to include lighting fixtures that appear in all respects to be standard table lamps and/or floor lamps. Hence, in such implementations, it is a benefit of the present invention to employ lamp designs in which all circuitry and electronics used to implement the present invention (for the master and slave lamps) to be included fully within the base of the table lamps.

In view of the foregoing discussion, it is intended that the appended claims be interpreted as including the embodiments described herein, the alternatives mentioned above, and all equivalents thereto.

What is claimed is:

1. A lighting system, comprising:
a master lighting fixture having a base, a light source, a set of control buttons, and a master controller contained within the base; and
one or more slave lighting fixtures, each of the slave lighting fixtures having a base, a light source, and a slave controller fully contained within the base of the respective slave lighting fixture,
the master controller adapted to control, in response to selective depression of the control buttons, an intensity level of the light source of the master lighting fixture and to wirelessly transmit a control signal to the one or more slave lighting fixtures, the transmitted control signal corresponding to an intensity level of one or more of the slave lighting fixtures;
the slave controller of each of the one or more slave lighting fixtures including a receiver for receiving the transmitted control signal and adapted to control an intensity level of the light source of the respective slave lighting fixture based on the received control signal.

2. The lighting system of claim 1, wherein the control buttons of the master lighting fixture include, for each of the master lighting fixture and the one or more slave lighting fixtures, a respective dedicated button adapted to selectively control an intensity level of the light source of the respective lighting fixture.

3. The lighting system of claim 2, wherein the master controller of the master lighting fixture is adapted to selectively cycle a selected one of the lighting fixtures through a plurality of intensity levels upon multiple depressions of the respective dedicated button.

4. The lighting system of claim 1, wherein the master controller of the master lighting fixture includes memory for storing data identifying a previously set intensity level of each of the lighting fixtures.

5. The lighting system of claim 1, further comprising a remote control having a plurality of buttons and adapted to wirelessly transmit a remote control signal in accordance with depression of the buttons by a user of the remote control; and wherein the master controller is adapted to receive the transmitted remote control signal and to selectively establish one or more of the lighting fixtures to a respective intensity level in accordance with the received remote control signal.

6. The lighting system of claim 1, further comprising a remote control having a plurality of buttons and adapted to wirelessly transmit a remote control signal in accordance with depression of the buttons by a user of the remote control; and wherein the master controller and the slave controller of each of the one or more slave lighting fixtures are adapted to receive the transmitted remote control signal and to establish the respective lighting fixture to a respective intensity level in accordance with the received remote control signal.

7. The lighting system of claim 1, wherein each of the master lighting fixture and the one or more slave lighting fixtures is a table lamp.

8. The lighting system of claim 1, wherein the master lighting fixture and the one or more slave lighting fixtures have matching appearances.

9. The lighting system of claim 1, wherein the master lighting fixture is one of a table lamp and a floor lamp, and at least one of the slave lighting fixtures is the other of a table lamp and a floor lamp.
